(19) United States
(12) Patent Application Publication
(10) Pub. No.: US 2021/0178594 A1
(43) Pub. Date: Jun. 17, 2021

(54) Robot, Action Detection Server, and Action Detection System

(71) Applicant: Hitachi, Ltd., Chiyoda ku, Tokyo (JP)

(72) Inventors: Masanao KOTANI, Tokyo (JP); Kohei KYOYA, Tokyo (JP)

(21) Appl. No.: 17/048,471

(22) PCT Filed: Feb. 27, 2019
(86) PCT No.: PCT/JP2019/007507

§ 371 Date: Oct. 16, 2020

(30) Foreign Application Priority Data
May 28, 2018 (JP) 2018-101400

(51) Int. Cl. B25J 9/16; B25J 13/08; B25J 9/02

(52) U.S. Cl. CPC B25J 9/1674; B25J 9/023; B25J 9/1664; B25J 13/089

(57) ABSTRACT

To ensure privacy of a user while preventing transmission of erroneous information caused by malfunction of a sensor. An action detection system includes: a plurality of sensor devices including a detection unit that detects information and a communication unit that transmits information, the sensor devices provided in anywhere in a living environment; a mobile robot including a detection unit that detects information, a communication unit that transmits and receives information, and a movement means capable of moving in the living environment; and an action detection server including a communication unit that transmits and receives information, the server that detects a state on the basis of detection information of the detection unit included in the plurality of sensor devices and detection information of the detection unit included in the mobile robot.

### TECHNICAL FIELD

The present invention relates to a robot that cooperates with a plurality of sensors provided in a room, an action detection server that cooperates with the sensors and the robot, and an action detection system including the sensors, the robot, and the action detection server.

### BACKGROUND ART

There is a conventional technique to manage a sensor for efficiently grasping the location and state of a user in order to grasp the activity of the user and to control an appliance in accordance with the state of each user. The technique disclosed in PTL 1 is such kind of technique. The abstract of PTL 1 describes that “There is provided a management server 20 connected with a plurality of sensors 10. A control unit 21 in the management server 20 detects a human on the basis of sensor information acquired from the sensors 10 and executes recording processing of whereabouts in an individual information storage unit 25. Further, the control unit 21 executes state detection processing, used device detection processing, and used amount recording processing in the individual information storage unit 25. Then, the control unit 21 executes the tracking processing of a human. In the case of having determined that a user is identifiable, the control unit 21 executes recording processing of user information in the individual information storage unit 25.”

### CITATION LIST

### Patent Literature

PTL 1: JP 2015-146514 A

### SUMMARY OF INVENTION

### Technical Problem

In a system that detects human actions by a sensor provided in a room, the sensor sometimes malfunctions due to an operation of an appliance provided in the room. Furthermore, in such system, when the appliance provided in the room moves in the room, the sensor sometimes malfunctions and transmits erroneous detection information.

For example, in a system that detects human actions with a motion detector provided in a room, when the user goes out with the window open and wind blows in from outside the window, the detector may malfunction due to the movement of the curtain induced by the wind. On the other hand, in the case where a plurality of cameras are provided in the room in order to prevent the malfunction described above, problems arise from the points of view of ensuring privacy, introduction cost, operation cost, and the like.

The present invention is made for the problem described above, and its object is to provide an action detection system capable of ensuring privacy of a user while preventing transmission of erroneous information caused by malfunction of a sensor.

### Solution to Problem

In order to solve the problem described above, an action detection system according to the present invention is built with a plurality of sensor devices including a first sensor that detects information and a first communication means for transmitting information, and provided in anywhere in a room, a robot including a second sensor that detects information, a second communication means for transmitting and receiving information, and a movement means capable of moving in the room, and a server including a third communication means for transmitting and receiving information, the server that detects a state on the basis of detection information of the first sensor included in the plurality of sensor devices and detection information of the second sensor included in the robot.

Other means will be described in Description of Embodiments.

### Advantageous Effects of Invention

According to the present invention, it is possible to ensure privacy of a user while preventing transmission of erroneous information caused by malfunction of a sensor.

### BRIEF DESCRIPTION OF DRAWINGS

FIG. 1 is a schematic view illustrating a configuration of an action detection system in a first embodiment.

FIG. 2 is a view illustrating a habitable room in which the detection system of the first embodiment is installed.

FIG. 3 is a view illustrating an example of sensor installation information (SI).

FIG. 4 is a view illustrating an example of event information (EI).

FIG. 5 is a view illustrating a habitable room in a sensor installation information (SI) mode.

FIG. 6 is a graph illustrating sensor information (GI).

FIG. 7 is a flowchart illustrating processing of a sensor information creation mode.

FIG. 8 is a flowchart illustrating processing of the sensor installation information mode.

FIG. 9 is a view illustrating a habitable room in an event information mode.

FIG. 10 is a graph illustrating sensor information (GI) in the event information mode.

FIG. 11 is a flowchart illustrating processing of the event information mode.

FIG. 12 is a graph to which only event information is extracted.

FIG. 13 is a flowchart illustrating processing in the event information mode when a mobile robot is not activated.

FIG. 14 is a flowchart illustrating processing in the event information mode when the mobile robot is activated.

FIG. 15 is a view illustrating a habitable room at the time of abnormality detection.

FIG. 16 is a graph to which missing event information is extracted.

FIG. 17 is a flowchart illustrating processing of an abnormality detection mode.

FIG. 18 is a schematic view illustrating the configuration of the action detection system in a second embodiment.

FIG. 19 is a view illustrating a habitable room in which the detection system of the second embodiment is installed.

FIG. 20 is a view illustrating an example of home appliance installation information (HI).

FIG. 21 is a view illustrating an example of event information (EI).

FIG. 22 is a graph of home appliance information detected by the robot.

FIG. 23 is a flowchart illustrating processing of a home appliance installation information mode.

FIG. 24 is a flowchart illustrating processing in the event information mode when the mobile robot is not activated.

FIG. 25 is a flowchart illustrating processing in the event information mode when the mobile robot is activated.

### DESCRIPTION OF EMBODIMENTS

### First Embodiment

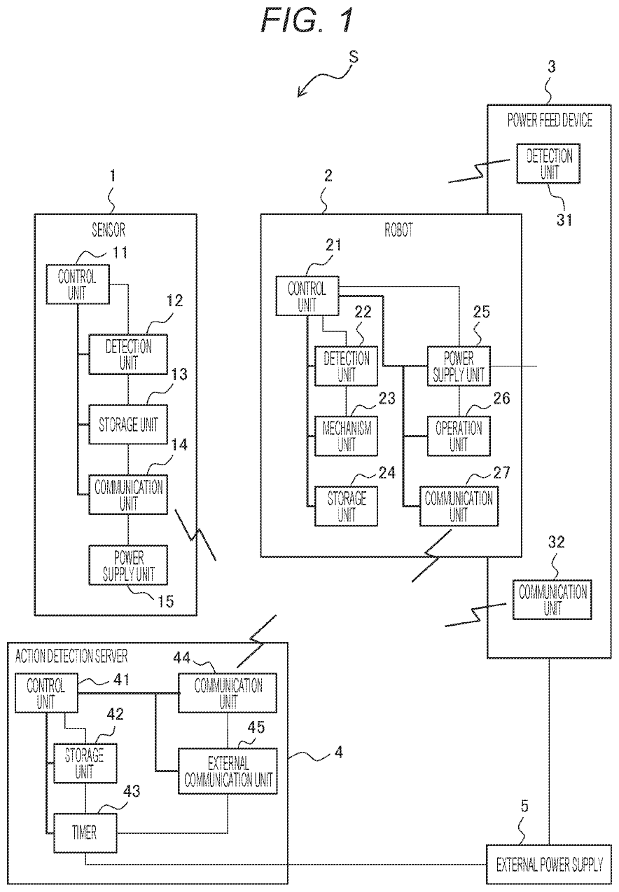

An action detection system S of the first embodiment will be described below with reference to FIGS. 1 to 18.

FIG. 1 is a schematic view illustrating the configuration of the action detection system S.

As illustrated in FIG. 1, the action detection system S is configured to include a plurality of sensor devices 1, a mobile robot 2, a power feed device 3, and an action detection server 4.

The sensor device 1 is provided in a room, senses information, and transmits the information to the outside by a communication unit 14. The mobile robot 2 is a robot having a detection unit 22, a mechanism unit 23, and the like, and capable of moving in the room. The mobile robot 2 is a robot having a cleaning function, for example, but it is not limited to this. It may be a pet robot or a security robot, and is not limited.

The power feed device 3 supplies power to the mobile robot 2. A control unit 41 of the action detection server 4 has a communication unit 44 that communicates with the plurality of sensor devices 1 and the mobile robot 2. On the basis of detection information of those connected sensor devices 1 and the mobile robot 2, actions and/or the state of a mobile body such as a human, an animal, or another robot device are detected.

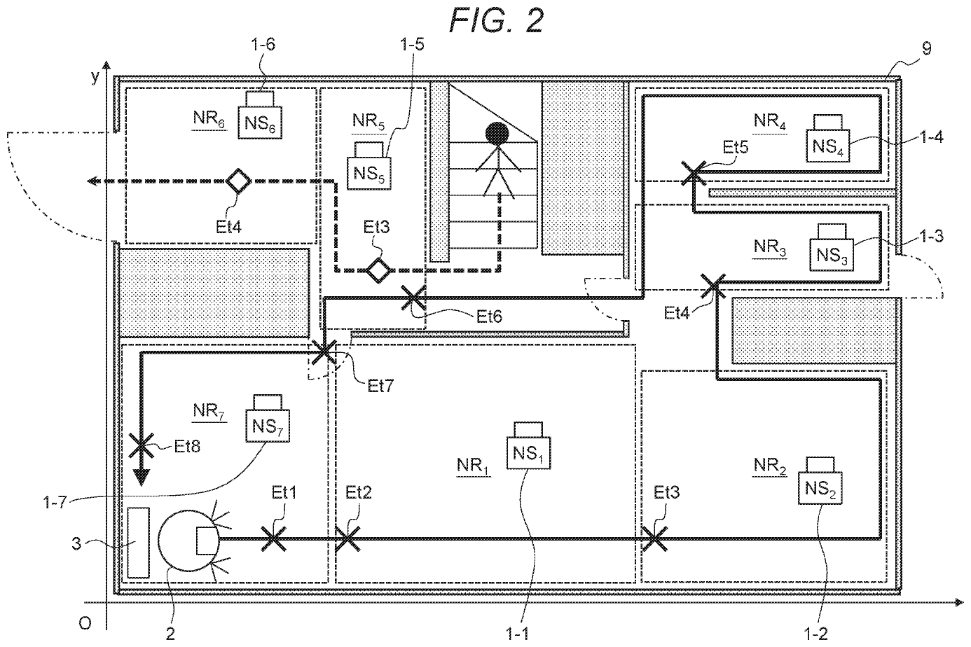

The plurality of sensor devices 1 include a control unit 11, a detection unit 12 (first sensor), a storage unit 13, a communication unit 14 (first communication means), and a power supply unit 15, and the plurality of sensor devices 1 are installed in a habitable room 9 illustrated in FIG. 2.

The power supply unit 15 activates the sensor device 1 and supplies power to each unit. The communication unit 14 is a wireless or wired communication module and transmits detection information of the sensor device 1 and a unique ID (IDentifier) of the sensor device 1 to the action detection server 4. The storage unit 13 is, for example, a read only memory (ROM) or a flash memory, and stores a unique ID of the sensor device 1 and the like. The detection unit 12 functions as a first sensor that detects indoor information. The detection unit 12 is a motion detector that detects a human and the like by, for example, infrared rays or ultrasonic waves, and the detection unit 12 can detect a mobile body such as a human and a mobile robot. The control unit 11 controls the operation of the detection unit 12.

The mobile robot 2 includes a power supply unit 25, the mechanism unit 23 (movement means), the detection unit 22 (second sensor), a control unit 21, a storage unit 24, a communication unit 27 (second communication means), and an operation unit 26. The mobile robot 2 includes a secondary battery (not illustrated) in the power supply unit 25, and operates by charging the secondary battery with the power feed device 3.

The power supply unit 25 activates the mobile robot 2 and supplies power to each unit of the mobile robot 2. The mechanism unit 23 is for moving in the room and is composed of, for example, a motor and wheels. The mechanism unit 23 functions as a movement means movable inside the habitable room 9.

The detection unit 22 functions as a second sensor that detects indoor information. The detection unit 22 is a group of sensors for detecting the position of the mobile robot 2 and detecting the action of a mobile body such as a human and an animal. The control unit 21 is, for example, a central processing unit (CPU) that analyzes detection information of the detection unit 22, and controls the operation of the mobile robot 2 on the basis of the analyzed information. The storage unit 24 is, for example, a random access memory (RAM) or a flash memory, and stores information analyzed by the control unit 21. The communication unit 27 is a communication module of Wi-Fi (registered trademark), for example, and transmits and receives information between the control unit 21 and the action detection server 4. The operation unit 26 is a switch, a button, or the like for the user to operate the mobile robot 2.

The power feed device 3 supplies power to the mobile robot 2. The power feed device 3 includes a detection unit 31 and a communication unit 32. The detection unit 31 is a sensor that detects the position of the mobile robot 2. The communication unit 32 is a communication module of Wi-Fi (registered trademark), for example, and transmits and receives information between the control unit 21 and the action detection server 4.

It is to be noted that the detection unit 22 of the mobile robot 2 is configured to include a group of sensors such as infrared, ultrasonic, laser, acceleration, camera, and voice recognition, and a group of sensors that detect the operation of the mechanism unit 23. The detection unit 22 is a detection means including a position sensor for detecting geometric information of a space in which the mobile robot 2 itself has moved. This allows the mobile robot 2 to move in the room. The control unit 21 can recognize its self position by using operation information of the mechanism unit 23 and detection information of the group of sensors. As a result, the control unit 21 of the mobile robot 2 causes the detection unit 22 to analyze the geometric information of the habitable room 9 and causes the storage unit 24 to store the analyzed geometric information (living space map). This allows the control unit 21 to recognize the position of the mobile robot 2 itself. When the communication unit 27 receives destination information (geometric information), the mobile robot 2 can move to the destination.

The control unit 21 of the mobile robot 2 can transmit spatial information (GI) of its self position to the action detection server 4 via the communication unit 27. Furthermore, the control unit 21 of the mobile robot 2 also includes a recognition means for causing the detection unit 22 to recognize, using an image and a voice, actions of the mobile body such as a human and an animal. This allows the control unit 21 of the mobile robot 2 to transmit the information on the state of the mobile body having been detected to the action detection server 4 via the communication unit 27. Upon receiving information on the state, the control unit 41 of the action detection server 4 can transmit the information on the state to the outside via an external communication unit 45.

The action detection server 4 is configured to include the control unit 41, a storage unit 42, a timer 43, the communication unit 44 (third communication means), and the external communication unit 45. The communication unit 44 is a communication module of Wi-Fi (registered trademark), for example, and receives information transmitted from the sensor device 1 and the mobile robot 2, and transmits information to the mobile robot 2. The communication unit 44 functions as the third communication means capable of communicating with the plurality of sensor devices 1 provided in the room and the mobile robot 2.

The external communication unit 45 is, for example, a network interface card (NIC), and transmits/receives information to/from an external network other than the network built with the sensor device 1 and the mobile robot 2. The control unit 41 analyzes information received from the sensor device 1, the mobile robot 2, and the external communication unit 45, and controls the mobile robot 2 on the basis of the analysis result. The control unit 41 functions as a control means for detecting actions of a mobile body on the basis of sensor information (first detection information) detected by the plurality of sensor devices 1 and information (second detection information) detected by the detection unit 22 of the mobile robot 2.

The storage unit 42 stores input information from the external communication unit 45 and control information of the control unit 41. The storage unit 42 is a storage means for storing sensor position information indicating the positions where the plurality of sensor devices 1 are installed, and the correspondence relationship between geometric information of the space where the mobile robot 2 has moved and information on the positions where the plurality of sensor devices 1 are provided. The control unit 41 stores, in the storage unit 42, a position where each sensor device 1 is provided, as position information expressed by a coordinate system of the space that the mobile robot 2 has detected by the position sensor. The timer 43 recognizes the occurrence time point of an event.

It is to be noted that each function of the action detection server 4 may be incorporated in the mobile robot 2 or the sensor device 1.

FIG. 2 is a view illustrating the habitable room 9 in which the action detection system S of the first embodiment is installed.

While the habitable room 9 is a room of a home or the like, it may be a company office, a warehouse or the like and is not limited. In the habitable room 9, seven sensor devices 1-1 to 1-7 and the power feed device 3 are installed, and the mobile robot 2 circulates along the route indicated by the thick arrow. The positions of the mobile robot 2 and a human at each event time point Et1 to Et8 are illustrated on the route of the thick arrow.

In the habitable room 9, the sensor devices 1-7, 1-1, and 1-2 are installed in a living room, and the power feed device 3 is installed in the vicinity of the sensor device 1-7. Furthermore, the sensor device 1-3 is installed in a kitchen, and the sensor device 1-4 is installed in a dining room in the back of the kitchen. The sensor device 1-5 is installed in a corridor down stairs, and the sensor device 1-6 is installed in an entrance. It is to be noted that each sensor device 1-1 to 1-7 is simply referred to as the sensor device 1 when they are not particularly distinguished.

The sensor device 1-7 is given NS7 as a unique ID. A feature space NR7, which is a detection range of the sensor device 1-7, is the left side of a living room as indicated by the broken line.

The sensor device 1-1 is given NS1 as a unique ID. A feature space NR1, which is a detection range of the sensor device 1-1, is the right side of the living room as indicated by the broken line.

The sensor device 1-2 is given NS2 as a unique ID. A feature space NR2, which is a detection range of the sensor device 1-2, is the right side of the living room as indicated by the broken line.

The sensor device 1-3 is given NS3 as a unique ID. A feature space NR3, which is a detection range of the sensor device 1-2, is the kitchen as indicated by the broken line.

The sensor device 1-4 is given NS4 as a unique ID. A feature space NR4, which is a detection range of the sensor device 1-4, is the dining room as indicated by the broken line.

The sensor device 1-5 is given NS5 as a unique ID. A feature space NR5, which is a detection range of the sensor device 1-5, is the corridor as indicated by the broken line.

The sensor device 1-6 is given NS6 as a unique ID. A feature space NR6, which is a detection range of the sensor device 1-6, is the entrance as indicated by the broken line.

Due to the above, the plurality of sensor devices 1-1 to 1-7 installed in the habitable room 9 can transmit, to the action detection server 4, information in which the unique ID (NS) of each sensor device 1 is given to detection information (SD) of the sensor device 1.

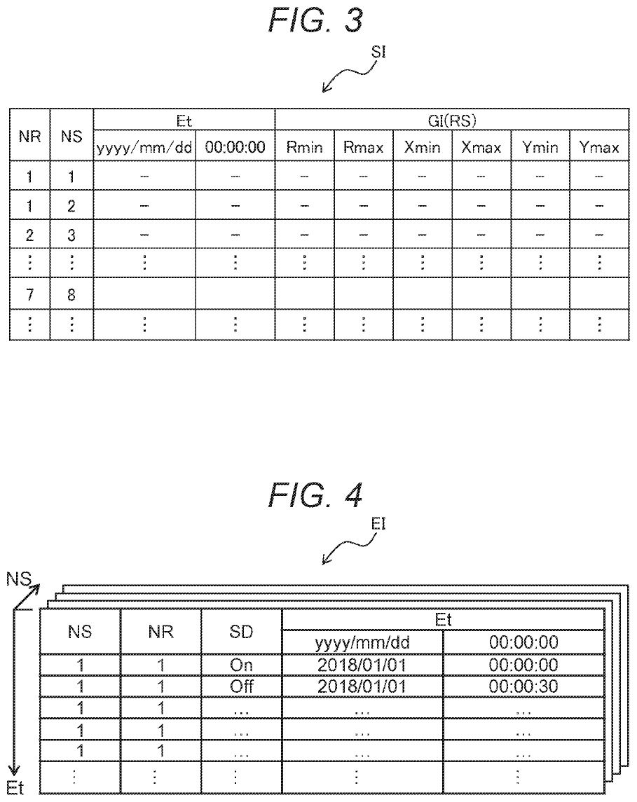

FIG. 3 is a view illustrating an example of sensor installation information (SI).

The action detection server 4 is provided with the storage unit 42. The storage unit 42 stores, in advance, sensor installation information (SI) indicating the relationship between the individual ID (NR1 to NR7) for the feature spaces of the habitable room 9 and the unique ID (NS) of the installed sensor device 1.

To the sensor installation information (SI), geometric information (GI) related to detection area information (RS) can be additionally stored. Furthermore, since the control unit 41 of the action detection server 4 is provided with the timer 43, the time point when data (NSi, SDi) of the sensor devices 1 are received can be additionally stored as the event occurrence time point (Et).

FIG. 4 is a view illustrating an example of event information (EI).

The event information (EI) illustrated in FIG. 4 can be stored and held as data related to detection of human actions. The event information (EI) is managed as data for each sensor unique ID (NS). The event information (EI) is configured by storing and holding the ID (NRj) for each feature space of the habitable room 9, data (SD) of each sensor device 1, and the event occurrence time point (Et). It is to be noted that as illustrated in FIG. 3, the feature space (NR) and the sensor ID (NS) may not correspond to each other in a one-to-one relationship.

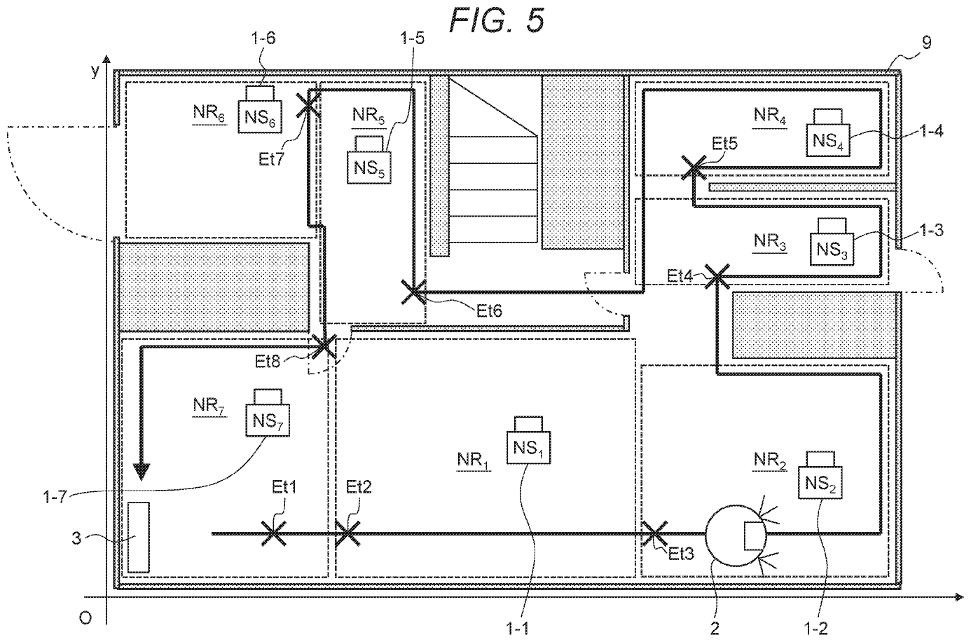

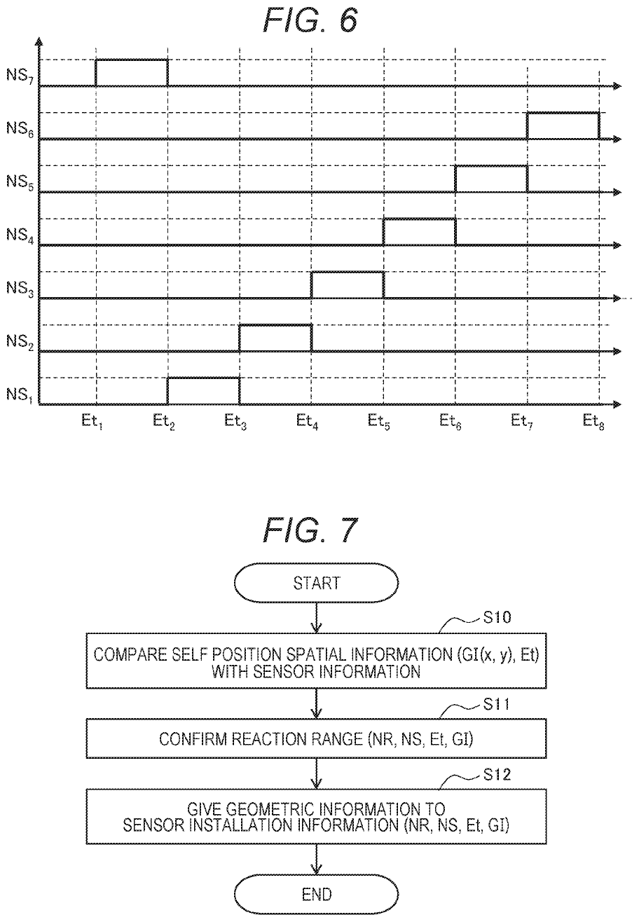

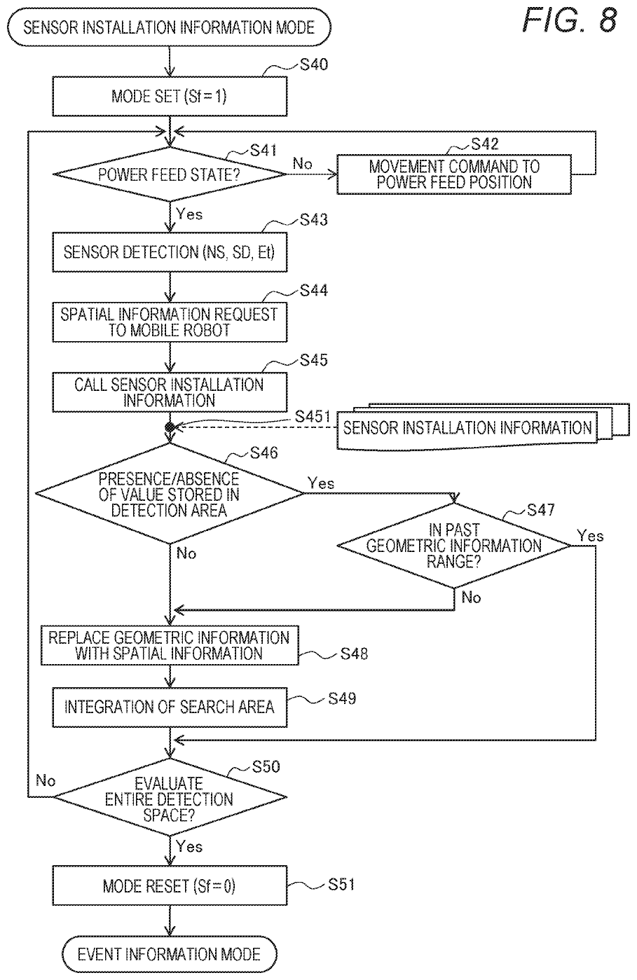

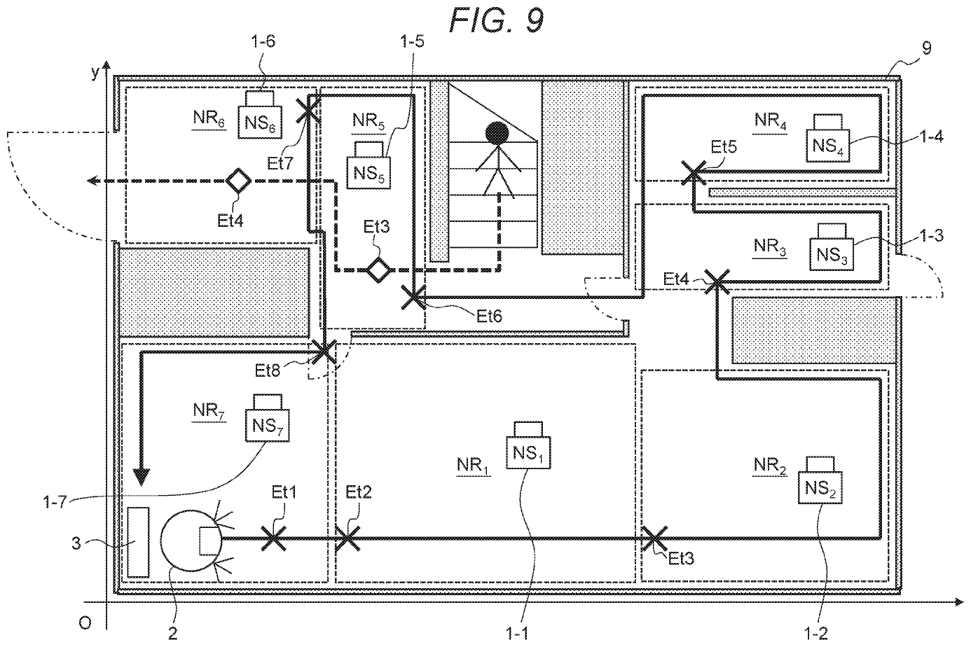

The addition of the spatial information (GI) to the sensor installation information (SI) will be described with reference to the flowcharts of FIGS. 7 and 8. FIG. 5 illustrates an outline of the operations of the sensor device 1 and the mobile robot 2 at the time of generation of the sensor installation information. FIG. 6 illustrates detection information of each sensor (NSi) for each time series. As illustrated in FIGS. 5 and 6, when the action detection server 4 receives a sensor installation information creation mode via the external communication unit 45, the control unit 41 of the action detection server 4 sets a sensor installation information flag Sf. When the sensor installation information flag Sf is set, the control unit 41 of the action detection server 4 transmits an activation signal to the mobile robot 2, and after the mobile robot 2 is activated, the control unit 41 stands by in a state of receiving responses of the sensor device 1 and the mobile robot 2.

As illustrated in FIG. 5, in accordance with the operation of the mobile robot 2, the sensor device 1-7 (NS7), the sensor device 1-1 (NS1), . . . , the sensor device 1-6 (NS6), and the sensor device 1-7 (NS7) sequentially react.

As illustrated in FIG. 6, the control unit 41 of the action detection server 4 receives the sensor detection data (NSi, SDi) in accordance with the reaction of each sensor device 1. At the time of reception of the sensor detection data (NSi, SDi), the control unit 41 acquires the event occurrence time point (Et) from the timer 43 and requests the mobile robot 2 to transmit its self position.

The mobile robot 2 is provided with the detection unit 22 that detects the position with respect to the power feed device 3, and can recognize its self position in the coordinate system illustrated in FIG. 5. In the control unit 21 of the mobile robot 2 upon receiving this request, the detection unit 22 measures coordinates (X, Y) with the power feed device 3 as the origin and an absolute distance R between the mobile robot 2 and the power feed device 3. Thereafter, the control unit 21 responds the measured coordinates (X, Y) and the absolute distance R to the action detection server 4.

As illustrated in FIG. 7, the control unit 41 of the action detection server 4 identifies the unique ID of the sensor device 1 that has detected the data from the received sensor detection data (NSi, SDi). The control unit 41 reads detection area coordinate information of the sensor device 1 corresponding to the sensor unique ID in the sensor installation information (SI). The detection area coordinate information includes a minimum value Rmin and a maximum value Rmax of the absolute distance R, a minimum value Xmin and a maximum value Xmax of the coordinate X, and a minimum value Ymin and a maximum value Ymax of the coordinate Y.

The control unit 41 compares the detection area information having been read with coordinate data (GI (R, X, Y)) received from the mobile robot 2 (S10). The control unit 41 determines whether or not the following expressions (1) and (2) are established, and confirms the reaction range (S11). The control unit 41 updates the detection area information (Rmax, Rmin, Xmin, Xmax, Ymax, Ymin) and gives geometric information to the sensor installation information (SI) (S12).

[Expression 1]

|R−Rₘₐₓ|>ε (1)

[Expression 2]

|R−Rₘᵢₙ|>ε (2)

As described above, by associating the detection information of the sensor device 1 with the coordinate information, the detection area of each sensor device 1 can be associated with the spatial coordinates of a living space map (LS) generated by the mobile robot 2.

FIG. 8 is a flowchart illustrating the processing of the sensor installation information (GI) mode.

In the sensor installation information mode, processing is performed as follows. After receiving the sensor installation mode, the control unit 41 of the action detection server 4 sets the sensor installation information flag Sf (S40).

In Step S41, the control unit 41 of the action detection server 4 determines whether or not the mobile robot 2 is in a power feed state. If determining that the mobile robot 2 is in the power feed state (Yes), the control unit 41 of the action detection server 4 proceeds to the processing of Step S43, and if determining that the mobile robot 2 is activated (No), the control unit 41 proceeds to the processing of Step S42.

In Step S42, the control unit 41 of the action detection server 4 commands the mobile robot 2 to move to the power feed position, and the process returns to Step S41. Thus, the control unit 41 stands by until the mobile robot 2 becomes in the power feed state.

In Step S43, the control unit 41 of the action detection server 4 acquires the event occurrence time point (Et) by the timer 43, and acquires the sensor detection data (NSi, SDi) from each sensor device 1. The control unit 41 holds the acquired sensor data as (Et, NSi, SDi) and proceeds to the processing of Step S44.

In Step S44, the control unit 41 of the action detection server 4 requests the spatial information from the mobile robot 2, acquires the spatial information (GI (R, X, Y)) from the mobile robot 2, and proceeds to the processing of Step S45.

In Step S45, the control unit 41 of the action detection server 4 calls the sensor installation information of the sensor ID (NSi) that is the detection target, and proceeds to the processing of Step S451.

In Step S451, the control unit 41 of the action detection server 4 reads the detection area information (RS), and then proceeds to the processing of Step S46. The detection area information (RS) includes information of (Rmax, Rmin, Xmin, Xmax, Ymax, Ymin).

In Step S46, the control unit 41 of the action detection server 4 determines whether or not a detection value has been input and stored in the detection area information (RS). If the detection area information (RS) does not exist (No), the control unit 41 proceeds to the processing of Step S48. If the detection value is stored in the detection area information (RS) (Yes), the control unit 41 proceeds to the processing of Step S47.

In Step S47, the control unit 41 of the action detection server 4 compares the detection area information (RS) with the spatial information (GI, (R, X, Y)). The control unit 41 checks whether the position information (GI, (R, X, Y)) of the mobile robot 2 is within the range of the detection area information (RS), i.e., within the past geometric information range. If it is not within the past geometric information range (No), the control unit 41 of the action detection server 4 proceeds to the processing of Step S48. If it is within the past geometric information range, the control unit 41 of the action detection server 4 proceeds to the processing of Step S50.

In Step S48, the control unit 41 of the action detection server 4 updates data by replacing the stored detection area information (RS) with the spatial information (GI (R, X, Y)) from the mobile robot 2, and proceeds to the processing of Step S49.

In Step S49, the control unit 41 of the action detection server 4 integrates and calculates the area of the search area, and proceeds to the processing of Step S50.

In Step S50, the control unit 41 of the action detection server 4 evaluates whether the integrated value of the search area matches the total area of the search space. If the integrated value of the search area matches the total area of the search space (Yes), the control unit 41 of the action detection server 4 proceeds to the processing of Step S51. If the integrated value of the search area does not match the total area of the search space (No), the control unit 41 of the action detection server 4 returns to the processing of Step S41.

In Step S51, the control unit 41 of the action detection server 4 clears the sensor installation information flag Sf, and ends the sensor installation information mode.

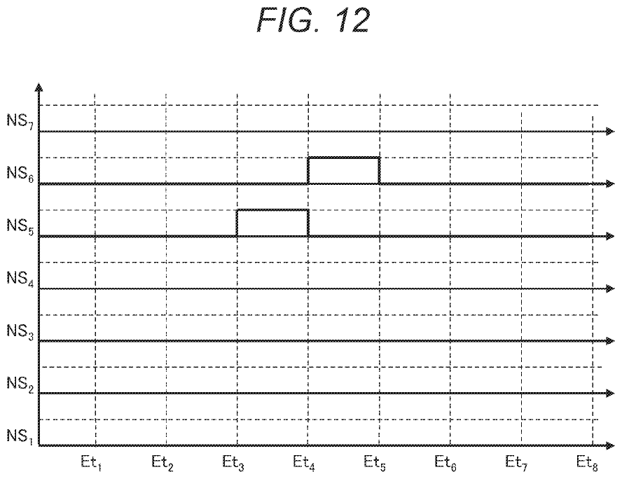

By using the above-described sensor installation information (SI), the control unit 41 of the action detection server 4 separately detects the reaction of the sensor device 1 with respect to the mobile robot 2 and the reaction of the sensor device 1 with respect to the action of the mobile body such as a human or an animal. Therefore, the control unit 41 can store the detection information of the sensor device 1 with respect to the action of the mobile body as the event information (EI). The procedure of separating the information detected by the sensor device 1 into the action of the mobile body and other data will be described below with reference to the flowcharts of FIGS. 11, 13, and 14.

FIG. 9 illustrates an outline of the reaction of the sensor device 1 when the mobile robot 2 and a human are acting simultaneously.

In the habitable room 9, seven sensor devices 1-1 to 1-7 and the power feed device 3 are installed, and the mobile robot 2 circulates along the route indicated by the thick arrow. The position at each event time point Et1 to Et8 is illustrated on the route of the thick arrow. The route of the mobile robot 2 illustrated in FIG. 9 is different from the route illustrated in FIG. 2. This is because the sensor installation information mode has been completed and the mode has transitioned to the event information mode.

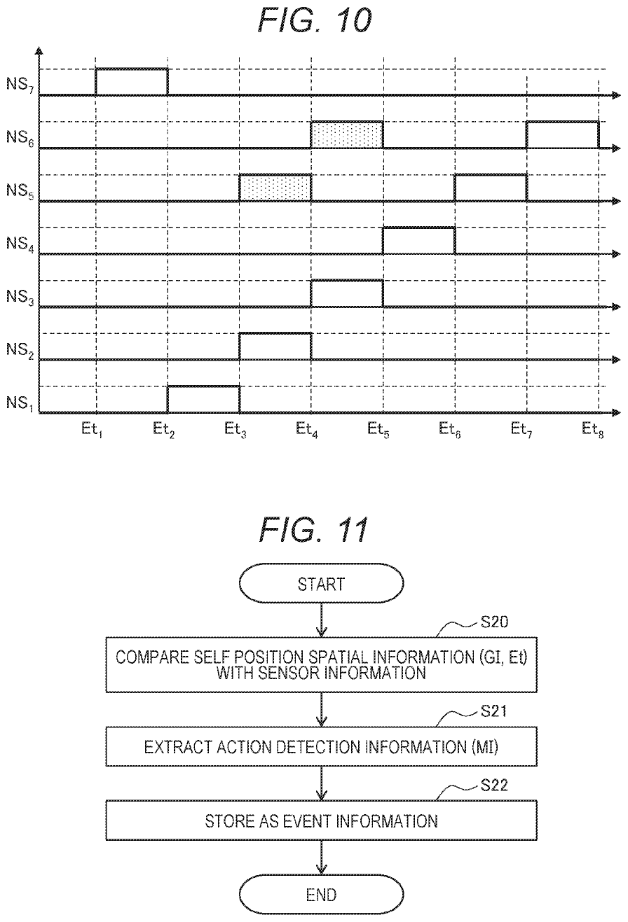

FIG. 10 illustrates detection information of the detected sensor (NSi) for each time series.

As illustrated in FIG. 10, each sensor device 1 reacts to each event time point every time the mobile robot 2 moves. That is, at the event time point Et1, the sensor device 1-7 (NS7) reacts. At the event time point Et2, the sensor device 1-1 (NS1) reacts. At the event time point Et3, the sensor device 1-2 (NS2) reacts. At the event time point Et4, the sensor device 1-3 (NS3) reacts. At the event time point Et5, the sensor device 1-4 (NS4) reacts. At the event time point Et6, the sensor device 1-5 (NS5) reacts. At the event time point Et7, the sensor device 1-6 (NS6) reacts. At the event time point Et8, the sensor device 1-7 (NS7) reacts.

Similarly, when the human acts, the sensor device 1-5 (NS5) reacts at the event time point Et3. At the event time point Et4, the sensor device 1-6 (NS6) reacts.

The control unit 41 of the action detection server 4 receives the spatial information (GI (R, X, Y)) of the self position of the mobile robot 2 every time it receives the detection information of the sensor devices 1-i (NSi). Thereafter, the control unit 41 compares the detection area (RS) stored in the sensor installation information (SI) with the spatial information (GI (R, X, Y)). Due to this, the control unit 41 generates the event information (EI) in which the data reacted by the operation of the mobile robot 2 and the other data are separated, and stores it in the storage unit 42 as the event information (EI).

FIG. 12 is a graph to which only event information (EI) is extracted.

As illustrated in FIG. 12, the sensor device 1-5 (NS5) is reacting at the event time point Et3. At the event time point Et4, the sensor device 1-6 (NS6) is reacting. This is detection information excluding the information of the detection of the mobile robot 2, and is information indicating that a human, an animal, or the like has been detected. In this manner, the control unit 41 can detect the action of the mobile body such as a human or an animal.

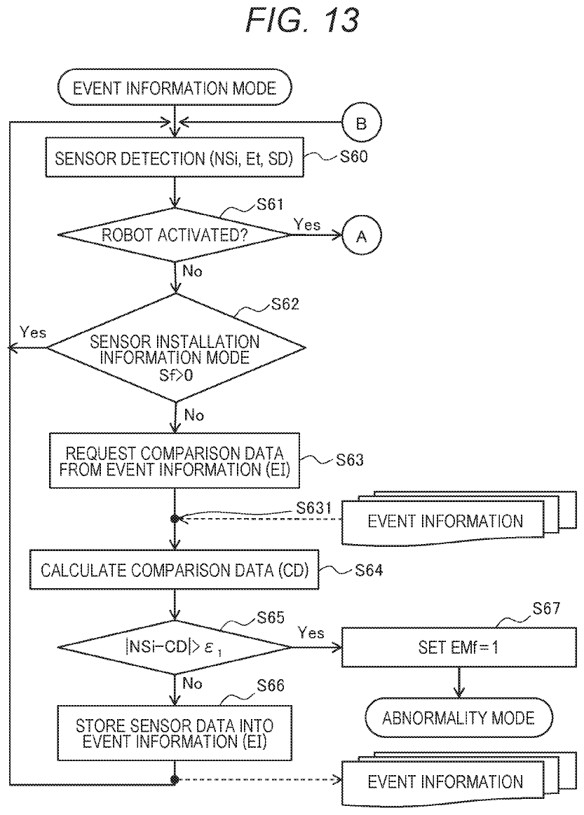

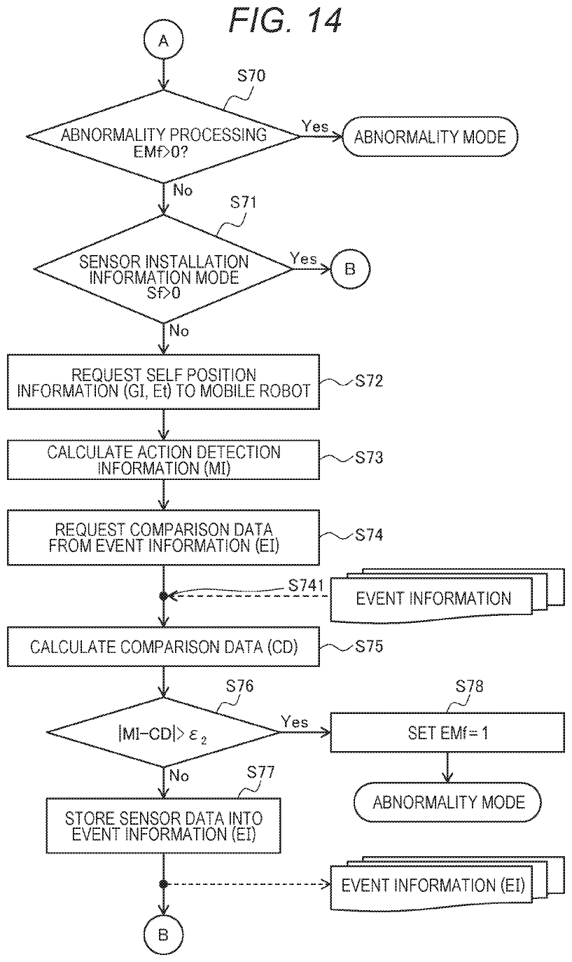

The event information mode described above is processed in FIGS. 13 and 14 below.

FIG. 13 is a flowchart illustrating processing the event information (EI) mode when the mobile robot 2 is not activated.

In the event information (EI) mode, the control unit 41 of the action detection server 4 receives (NSi, Et, SD), in Step S60, the sensor detection information from the sensor device 1, and proceeds to the processing of Step S61.

In Step S61, the control unit 41 of the action detection server 4 checks the presence/absence of activation to the mobile robot 2. If the mobile robot 2 is not activated (No), the control unit 41 proceeds to the processing of Step S62. If the mobile robot 2 is activated (Yes), the control unit 41 proceeds to Step S70 illustrated in FIG. 14.

In Step S62, the control unit 41 of the action detection server 4 judges whether or not it is the sensor installation information mode. If the sensor installation information flag Sf has not been set, the control unit 41 judges that the mode is the sensor installation information mode, and returns to the processing of Step S60. If the sensor installation information flag Sf has been cleared, the control unit 41 proceeds to the processing of Step S63.

In Step S63, the control unit 41 of the action detection server 4 requests past storage data of the target sensor (NSi) to the event information (EI), and proceeds to the processing of Step S631.

In Step S631, the control unit 41 of the action detection server 4 reads the past storage data of the target sensor (NSi) from the event information (EI), and proceeds to the processing of Step S64.

In Step S64, the control unit 41 of the action detection server 4 calculates comparison data from the past storage data, and proceeds to the processing of Step S65. The control unit 41 calculates the comparison data by averaging the received detection information (NSi, Et, SD), for example.

In Step S65, the control unit 41 of the action detection server 4 compares the detection information (NSi, Et, SD) with the comparison data (CD). If the difference exceeds a threshold value ε₁ (Yes), the control unit 41 judges that an unusual action has been detected, and proceeds to Step S67. The control unit 41 changes in Step S67 the mode to an abnormality mode, and sets an abnormality mode flag EMf to 1.

If the difference is equal to or less than the threshold value ε₁ (Yes), the control unit 41 of the action detection server 4 judges that it is a normal state, and adds the detection information to the event information (EI) (S66). Thereafter, the control unit 41 returns to the processing of Step S60.

FIG. 14 is a flowchart illustrating processing in the event information (EI) mode when the mobile robot 2 is activated.

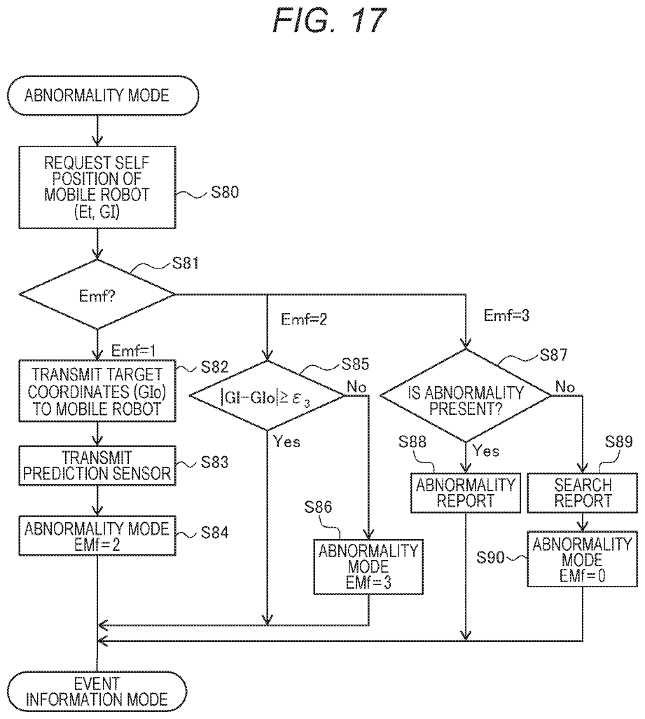

In Step S70, the control unit 41 of the action detection server 4 checks whether or not it is an abnormality processing mode by whether or not the abnormality mode flag EMf is set. If the control unit 41 judges that it is the abnormal processing mode (Yes), it transitions to the abnormality mode of FIG. 17. If the control unit 41 judges that it is not the abnormal processing mode (No), it proceeds to the processing of Step S71.

In Step S71, the control unit 41 of the action detection server 4 judges whether or not it is the sensor installation information mode. If the sensor installation information flag Sf has been set (Yes), the control unit 41 judges that it is the sensor installation information mode, and returns to the processing of Step S60. If the sensor installation information flag Sf has been cleared (No), the control unit 41 proceeds to the processing of Step S72.

In Step S72, the control unit 41 of the action detection server 4 requests the self position information GI (R, X, Y) to the mobile robot 2. When acquiring the self position information GI (R, X, Y) from the mobile robot 2, the control unit 41 proceeds to the processing of Step S73.

In Step S73, the control unit 41 of the action detection server 4 discriminates the detection information of the sensor device 1 reacting due to the mobile robot 2 from the self position information GI (R, X, Y) of the mobile robot 2 and the sensor installation information (SI). The control unit 41 discriminates that the detection information of the sensor devices 1 other than the sensor device 1 reacting due to the mobile robot 2 is action detection information (MI) of the mobile body such as a human or an animal, and proceeds to the processing of Step S74.

In Step S74, the control unit 41 of the action detection server 4 requests, to the event information (EI), data to be compared with the action detection information (MI).

In Step S741, the control unit 41 acquires the requested data, and proceeds to the processing of Step S75.

In Step S75, the control unit 41 of the action detection server 4 calculates the comparison data (CD) from the data obtained from the event information (EI), and proceeds to the processing of Step S76.

In Step S76, the control unit 41 of the action detection server 4 compares the action detection information (MI) with the comparison data (CD). If the result of the comparison exceeds a threshold value ε₂ (Yes), the control unit 41 of the action detection server 4 judges that it is an abnormal state, proceeds to the processing of Step S78, sets the processing state to the abnormality mode, and sets the abnormality mode flag EMf to 1. If the result of the comparison is equal to or less than the threshold value ε₂ (No), the control unit 41 proceeds to the processing of Step S77.

In Step S77, the control unit 41 of the action detection server 4 adds the action detection information (MI) to the event information (EI), and returns to the processing of Step S60.

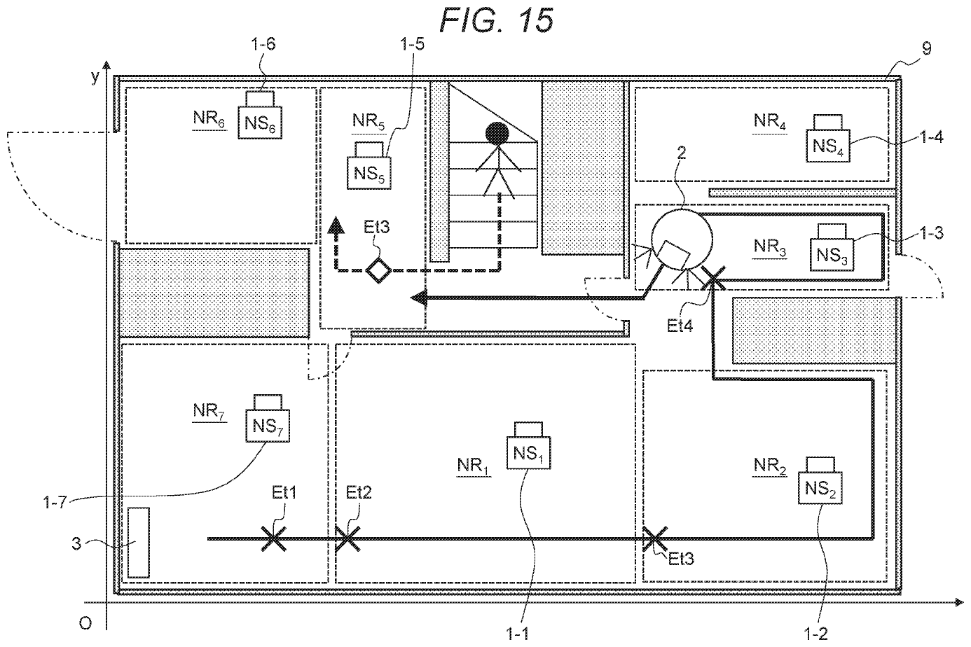

The control unit 41 of the action detection server 4 having shifted the processing to the abnormality mode performs the following processing as in FIGS. 15 to 17.

FIG. 15 illustrates the flow of processing at the time of an abnormal state in which there is no reaction of NS6 (sensor device 1-6) between Et4 and Et5 in a case where there is a reaction of NS5 (sensor device 1-5) between Et4 and Et5 in a daily action (event information (EI)).

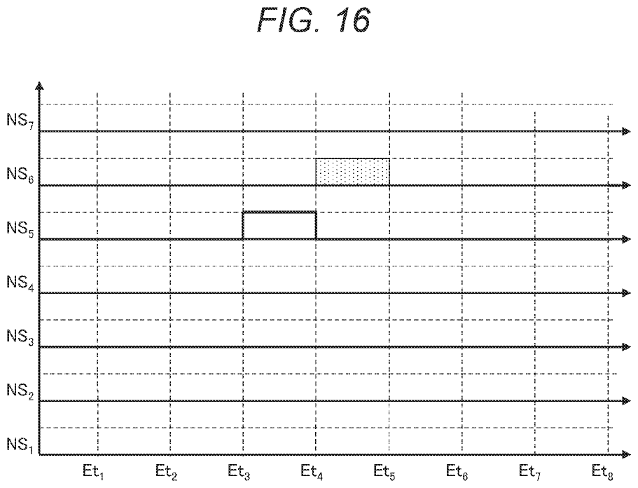

FIG. 16 illustrates detection information of the detected sensor (NSi) for each time series.

As illustrated in FIG. 16, if there is no sensor detection reaction between Et4 and Et5, the control unit 41 of the action detection server 4 compares the event information (EI) with the detection information (NSi, SD). If the difference between the event information (EI) and the detection information (NSi, SD) exceeds the threshold value, the control unit 41 judges that it is an abnormal action, and communicates the sensor installation information (SI (R, X, Y)) to the mobile robot 2 towards (NSi) where the abnormal action was found. If the event information (EI) and the detection information (NSi, SD) coincide with each other, the control unit 41 of the action detection server 4 continues the detection mode.

The above abnormality diagnosis mode is processed as follows in FIG. 17.

The control unit 41 of the action detection server 4 requests, in Step S80, the self position (GI (R, X, Y)) of the mobile robot 2, acquires the current position of the mobile robot 2, and proceeds to the processing of Step S81.

In Step S81, the control unit 41 of the action detection server 4 performs multiple branch in accordance with the abnormality mode flag. If the abnormality mode flag EMf is 1, the control unit 41 of the action detection server 4 proceeds to the processing of Step S82. If the abnormality mode flag EMf is 2, the control unit 41 of the action detection server 4 proceeds to the processing of Step S85. If the abnormality mode flag EMf is 3, the control unit 41 of the action detection server 4 proceeds to the processing of Step S87.

In Step S82, the control unit 41 of the action detection server 4 transmits, to the mobile robot 2, the fact that it is the abnormal state diagnosis mode, and transmits target coordinates GIo (NSi, R, X, Y) and a passing prediction sensor (PS) (S83). Furthermore, the control unit 41 sets the abnormality mode flag EMf to 2 (S84), and transitions to the event information mode.

In Step S85, the control unit 41 of the action detection server 4 compares the self position (GI) of the mobile robot 2 with the target coordinates (GIo), thereby judging whether or not the mobile robot 2 exists in the abnormality search area. If the difference between the self position (GI) and the target coordinate (GIo) is equal to or less than a threshold value ε₃ (No), the control unit 41 judges that the mobile robot 2 has moved to the abnormality search area, changes the abnormality mode flag EMf to 3 (S86), and transitions to the event information mode. If the difference between the self position (GI) and the target coordinate (GIo) exceeds the threshold value ε₃ (Yes), the control unit 41 judge that the mobile robot 2 has not reached the abnormality search area, and transitions to the event information mode.

In Step S87, the control unit 41 of the action detection server 4 judges that it is the abnormality search mode, and checks the presence/absence of an abnormality. For checking the presence/absence of an abnormality, the abnormality may be detected by using an image and a voice by an image sensor or a voice sensor provided in the detection unit 22 of the mobile robot 2. If an abnormality is detected in Step S87 (Yes), the control unit 41 proceeds to the processing of Step S88 to create an abnormality report, informs an external service of the abnormality by the external communication unit 45 provided in the action detection server 4 (S88), and transitions to the event information mode.

If no abnormality is detected in Step S87 (No), the control unit 41 proceeds to the processing of Step S89 to create a search report, and transmits the search report to an external service by the external communication unit 45 provided in the action detection server 4. After transmitting the search report, the control unit 41 of the action detection server 4 proceeds to the processing of Step S90, resets the abnormality diagnosis mode (S90), and transitions to the event information mode.

In the action detection system S of the present invention, the plurality of sensor devices 1 provided in the habitable room 9 cooperate with the mobile robot 2 having a movement means moving in the habitable room 9. This allows the action detection system S to ensure the privacy of the user while preventing the transmission of erroneous information caused by the malfunction of the sensor device 1.

### Second Embodiment

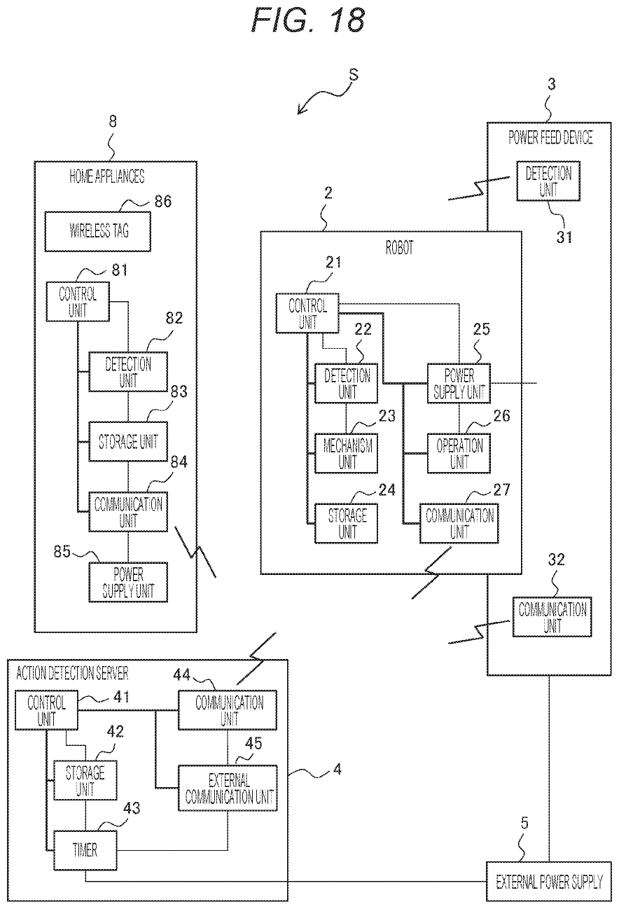

FIG. 18 is a schematic view illustrating the configuration of the action detection system in the second embodiment. In the second embodiment, a plurality of home appliances 8 are installed in the habitable room in place of the plurality of sensor devices 1, and operation information and detection information of the home appliances are detected in place of detection information of the sensor devices, thereby detecting human actions. The plurality of home appliances 8 include various functions as home appliances in addition to the functions of the sensor device 1 in the first embodiment.

As illustrated in FIG. 18, the action detection system S is configured to include the plurality of home appliances 8, the mobile robot 2, the power feed device 3, and the action detection server 4.

The home appliance 8 is installed in a habitable room to realize various functions, for example, a television, a lighting, an air conditioner, and the like. The home appliance 8 transmits operation information when the home appliance 8 itself is operated to the outside by the communication unit 14. The mobile robot 2 is a robot having the detection unit 22, the mechanism unit 23, and the like, and capable of moving in the habitable room (living environment). The power feed device 3 supplies power to the mobile robot 2. The control unit 41 of the action detection server 4 has a communication unit 44 that communicates with the plurality of home appliances 8 and the mobile robot 2. On the basis of detection information of those connected home appliances 8 and the mobile robot 2, actions and/or the state of a mobile body such as a human, an animal, or another robot device are detected.

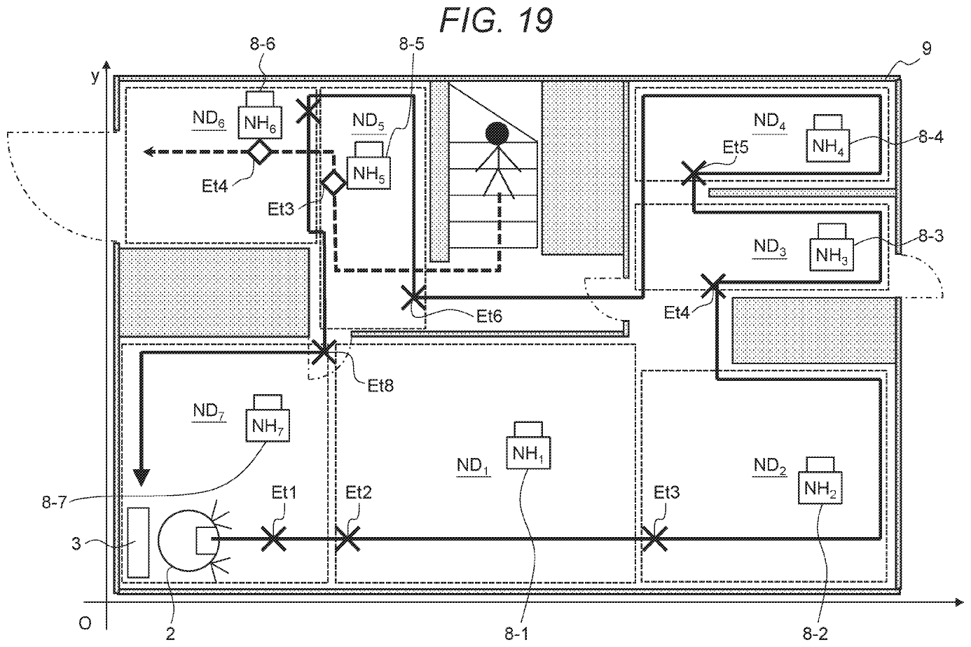

The plurality of home appliances 8 include a control unit 81, a detection unit 82, a storage unit 83, a communication unit 84, a power supply unit 85, and a wireless tag 86. The power supply unit 85 activates the home appliance 8 and supplies power to each unit of the home appliance 8. The communication unit 84 is a wireless or wired communication module and transmits operation information for the home appliance 8 and a unique ID of the home appliance 8 to the action detection server 4. The storage unit 83 is, for example, a ROM or a flash memory, and is built with the storage unit 83 for storing the unique ID of the home appliance 8, the detection unit 82, and the control unit 81 that controls the operation of the detection unit 82, and a plurality of them are installed in the habitable room 9 illustrated in FIG. 19.

The detection unit 22 of the mobile robot 2 is a group of sensors for detecting the position of the mobile robot 2 and the action of a mobile body such as a human and an animal. The detection unit 22 further has a function of detecting the wireless tag 86 included in the home appliance 8. The mobile robot 2 is configured similarly to that of the first embodiment except for the detection unit 22, and operates similarly to that of the first embodiment.

The power feed device 3 supplies power to the mobile robot 2. The power feed device 3 is configured similarly to that of the first embodiment and operates similarly to that of the first embodiment.

The detection unit 22 of the mobile robot 2 is configured to include a group of sensors such as infrared, ultrasonic, laser, acceleration, camera, and voice recognition, and a group of sensors that detect the operation of the mechanism unit 23. This can cause the control unit 21 of the mobile robot 2 capable of moving in the room to recognize its self position by using operation information of the mechanism unit 23 and detection information of the group of sensors. As a result, the control unit 21 allows the detection unit 22 to analyze the geometric information of the habitable room 9 and the storage unit 24 to store the analyzed geometric information (living space map), and can recognize its self position. When the communication unit 27 receives destination information (geometric information), the mobile robot 2 can move to the destination.

The control unit 21 of the mobile robot 2 can transmit spatial information (GI) of its self position to the action detection server 4 via the communication unit 27. Furthermore, the control unit 21 of the mobile robot 2 also includes a recognition means for causing the detection unit 22 to recognize, using an image and a voice, actions of the mobile body such as a human and an animal. This allows the control unit 21 of the mobile robot 2 to transmit the information on the state of the mobile body having been detected to the action detection server 4 via the communication unit 27. Upon receiving information on the state, the control unit 41 of the action detection server 4 can transmit the information on the state to the outside via an external communication unit 45.

The action detection server 4 is configured to include the control unit 41, a storage unit 42, a timer 43, the communication unit 44, and the external communication unit 45. The communication unit 44 is a communication module of Wi-Fi (registered trademark), for example, and receives information transmitted from the home appliance 8 and the mobile robot 2, and transmits information to the mobile robot 2.

The external communication unit 45 is, for example, a network interface card (NIC), and transmits/receives information to/from an external network other than the network built with the home appliance 8 and the mobile robot 2. The control unit 41 analyzes information received from the home appliance 8, the mobile robot 2, and the external communication unit 45, and controls the mobile robot 2 on the basis of the analysis result. The storage unit 42 stores input information from the external communication unit 45 and control information of the control unit 41. The timer 43 recognizes the occurrence time point of an event.

FIG. 19 is a view illustrating the habitable room 9 in which the action detection system S of the second embodiment is installed.

In the habitable room 9, seven home appliances 8-1 to 8-7 and the power feed device 3 are installed, and the mobile robot 2 circulates along the route indicated by the thick arrow. The position at each event time point Et1 to Et8 is illustrated on the route of the thick arrow.

In the habitable room 9, the home appliances 8-7, 8-1, and 8-2 are installed in the living room, and the power feed device 3 is installed in the vicinity of the home appliance 8-7. Furthermore, the home appliance 8-3 is installed in the kitchen, and the home appliance 8-4 is installed in the dining room in the back of the kitchen. The home appliance 8-5 is installed in the corridor down stairs, and the home appliance 8-6 is installed in the entrance. It is to be noted that each home appliance 8-1 to 8-7 is simply referred to as the home appliance 8 when they are not particularly distinguished.

The home appliance 8-7 is given NH7 as a unique ID. A feature space ND7, which is a range where the mobile robot 2 can detect the home appliance 8-7, is the left side of the living room as indicated by the broken line.

The home appliance 8-1 is given NH1 as a unique ID. A feature space ND1, which is a range where the mobile robot 2 can detect the home appliance 8-1, is the right side of the living room as indicated by the broken line.

The home appliance 8-2 is given NH2 as a unique ID. A feature space ND2, which is a range where the mobile robot 2 can detect the home appliance 8-2, is the right side of the living room as indicated by the broken line.

The home appliance 8-3 is given NH3 as a unique ID. A feature space ND3, which is a range where the mobile robot 2 can detect the home appliance 8-3, is the kitchen as indicated by the broken line.

The home appliance 8-4 is given NH4 as a unique ID. A feature space ND4, which is a range where the mobile robot 2 can detect the home appliance 8-4, is the dining room as indicated by the broken line.

The home appliance 8-5 is given NH5 as a unique ID. A feature space ND5, which is a range where the mobile robot 2 can detect the home appliance 8-2, is the corridor as indicated by the broken line.

The home appliance 8-6 is given NH6 as a unique ID. A feature space ND6, which is a range where the mobile robot 2 can detect the home appliance 8-2, is the entrance as indicated by the broken line.

By building the action detection system S with the configuration described above, the mobile robot 2 can detect the positions of the plurality of home appliances 8-1 to 8-7 installed in the habitable room 9. Furthermore, each home appliance 8 can transmit, to the action detection server 4, information in which the unique ID (NH) of the home appliance 8 is given to operation information and detection information (HD) of the home appliance.

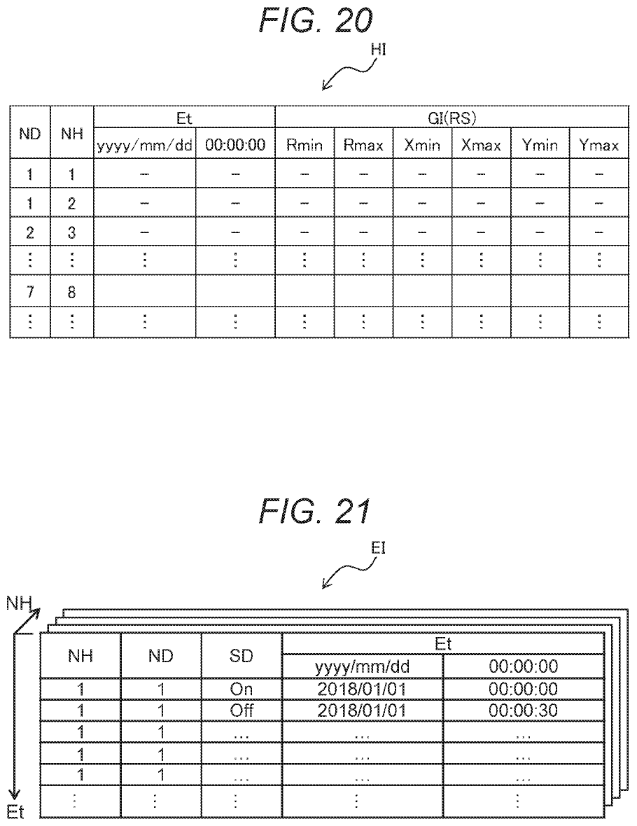

FIG. 20 is a view illustrating an example of home appliance installation information (HI).

The action detection server 4 is provided with the storage unit 42. The storage unit 42 stores home appliance installation information (HI) indicating the relationship between the individual ID (ND1 to ND7) for the feature spaces of the habitable room 9 and the unique ID (NH) of the installed home appliance 8.

To the home appliance installation information (HI), geometric information (GI) related to detection area information (RH) can be additionally stored. Furthermore, since the control unit 41 of the action detection server 4 is provided with the timer 43, the time point when data (NHi, HDi) of the home appliances 8 are received can be additionally stored as the event occurrence time point (Et).

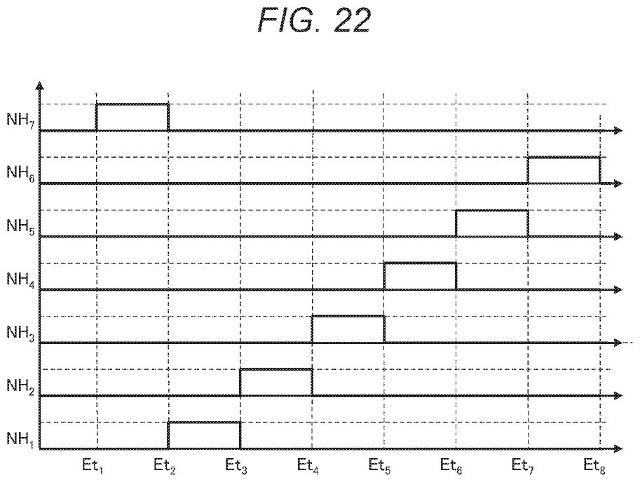

FIG. 21 is a view illustrating an example of event information (EI).

The event information (EI) illustrated in FIG. 21 is stored and held as data related to detection of human actions. The event information (EI) is managed as data for each unique ID (NH) of the electric appliance 8, and is configured by storing and holding the ID (ND) for each feature space of the habitable room 9, data (HD) of each home appliance 8, and the event occurrence time point (Et). FIG. 22 is a graph illustrating a time series of detection of the home appliance 8 by the robot.

When the action detection server 4 receives a home appliance installation information creation mode via the external communication unit 45, the control unit 41 of the action detection server 4 sets a home appliance installation information flag Hf. When the home appliance installation information flag Hf is set, the control unit 41 of the action detection server 4 transmits an activation signal to the mobile robot 2, and after the mobile robot 2 is activated, the control unit 41 stands by in a state of receiving responses of the home appliance 8 and the mobile robot 2. As illustrated in FIG. 21, in accordance with the operation of the mobile robot 2, the home appliance 8-7 (NH7), the home appliance 8-1 (NH1), the home appliance 8-2 (NH2), . . . the home appliance 8-6 (NH6), and the home appliance 8-7 (NH7) sequentially react.

As illustrated in FIG. 22, the control unit 41 of the action detection server 4 receives the home appliance detection data (NHi, HDi) in accordance with detection of each home appliance 8 by the mobile robot 2. At the time of reception of the home appliance detection data (NHi, HDi), the control unit 41 acquires the event occurrence time point (Et) from the timer 43 and requests the mobile robot 2 to transmit its self position. The mobile robot 2 is provided with the detection unit 22 that detects the position with respect to the power feed device 3, and can recognize its self position in the coordinate system illustrated in FIG. 19. In the control unit 21 of the mobile robot 2 upon receiving this request, the detection unit 22 measures coordinates (X, Y) with the power feed device 3 as the origin and an absolute distance R between the mobile robot 2 and the power feed device 3. Thereafter, the control unit 21 responds the measured coordinates (X, Y) and the absolute distance R to the action detection server 4.

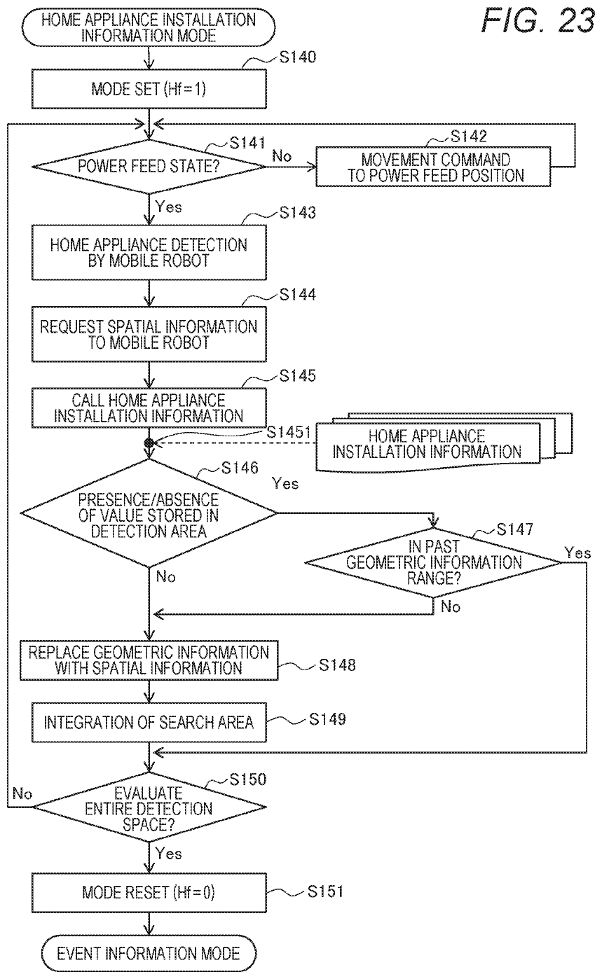

FIG. 23 is a flowchart illustrating processing of a home appliance installation information mode.

In the home appliance installation information mode, processing is performed as follows. After receiving the home appliance installation information mode, the control unit 41 of the action detection server 4 sets the home appliance installation information flag Hf (S140).

In Step S141, the control unit 41 of the action detection server 4 determines whether or not the mobile robot 2 is in a power feed state. If determining that the mobile robot 2 is in the power feed state (Yes), the control unit 41 of the action detection server 4 proceeds to the processing of Step S143, and if determining that the mobile robot 2 is activated (No), the control unit 41 proceeds to the processing of Step S142.

In Step S142, the control unit 41 of the action detection server 4 commands the mobile robot 2 to move to the power feed position, and the process returns to Step S141. Thus, the control unit 41 stands by until the mobile robot 2 becomes in the power feed state.

In Step S143, the control unit 41 of the action detection server 4 acquires the event occurrence time point (Et) by the timer 43, and acquires the home appliance operation data (NSi, HDi) from each home appliance 8. The control unit 41 holds the acquired operation data as (Et, NHi, HDi) and proceeds to the processing of Step S144.

In Step S144, the control unit 41 of the action detection server 4 requests the spatial information from the mobile robot 2, acquires the spatial information (GI (R, X, Y)) from the mobile robot 2, and proceeds to the processing of Step S145.

In Step S145, the control unit 41 of the action detection server 4 calls the home appliance installation information of the home appliance ID (NHi) that is the detection target, and proceeds to the processing of Step S1451.

In Step S1451, the control unit 41 of the action detection server 4 reads the detection area information (RH), and then proceeds to the processing of Step S146. The detection area information (RH) includes information of (Rmax, Rmin, Xmin, Xmax, Ymax, Ymin).

In Step S146, the control unit 41 of the action detection server 4 determines whether or not a detection value has been input and stored in the detection area information (RH). If the detection area information (RH) does not exist (No), the control unit 41 proceeds to the processing of Step S148. If the detection value is stored in the detection area information (RH) (Yes), the control unit 41 proceeds to the processing of Step S147.

In Step S147, the control unit 41 of the action detection server 4 compares the detection area information (RH) with the spatial information (GI, (R, X, Y)). By this comparison, the control unit 41 checks whether the position information (GI, (R, X, Y)) of the mobile robot 2 is within the range of the detection area information (RH), i.e., within the past geometric information range. If it is not within the past geometric information range (No), the control unit 41 of the action detection server 4 proceeds to the processing of Step S148. If it is within the past geometric information range (Yes), the control unit 41 of the action detection server 4 proceeds to the processing of Step S150.

In Step S148, the control unit 41 of the action detection server 4 updates data by replacing the stored detection area information (RH) with the spatial information (GI (R, X, Y)) from the mobile robot 2, and proceeds to the processing of Step S149.

In Step S149, the control unit 41 of the action detection server 4 integrates and calculates the total area of the search area, and proceeds to the processing of Step S150.

In Step S150, the control unit 41 of the action detection server 4 evaluates whether the integrated value of the search area matches the total area of the search space. If the integrated value of the search area matches the total area of the search space (Yes), the control unit 41 of the action detection server 4 proceeds to the processing of Step S151. If the integrated value of the search area does not match the total area of the search space (No), the control unit 41 of the action detection server 4 returns to the processing of Step S141.

In Step S151, the control unit 41 of the action detection server 4 clears the home appliance installation information flag Hf, and ends the home appliance installation information mode.

By using the above-described home appliance installation information (HI), the control unit 41 of the action detection server 4 can detect the position where the home appliance 8 is installed.

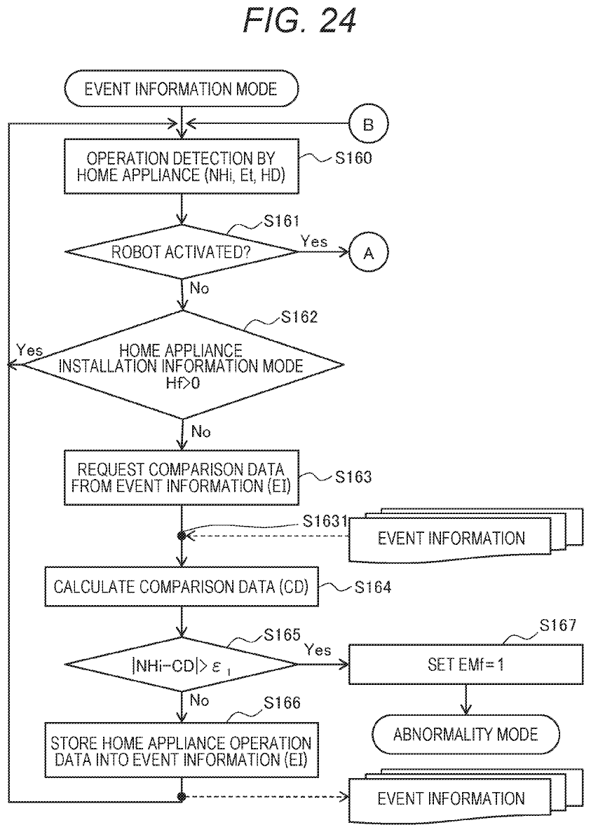

FIG. 24 is a flowchart illustrating processing in the event information (EI) mode when the mobile robot 2 is not activated.

In the event information (EI) mode, the control unit 41 of the action detection server 4 receives (NHi, Et, HD), in Step S160, the operation information from the home appliance 8, and proceeds to the processing of Step S161.

In Step S161, the control unit 41 of the action detection server 4 checks the presence/absence of activation to the mobile robot 2. If the mobile robot 2 is not activated (No), the control unit 41 proceeds to the processing of Step S163. If the mobile robot 2 is activated (Yes), the control unit 41 proceeds to Step S70 illustrated in FIG. 14.

In Step S162, the control unit 41 of the action detection server 4 judges whether or not it is the home appliance installation information mode. If the home appliance installation information flag Hf has been set (Yes), the control unit 41 judges that it is the home appliance installation information mode, and returns to the processing of Step S160. If the home appliance installation information flag Hf has been cleared (No), the control unit 41 proceeds to the processing of Step S163.

In Step S163, the control unit 41 of the action detection server 4 requests past operation data for the target home appliance 8 (NHi) to the event information (EI), and proceeds to the processing of Step S1631.

In Step S1631, the control unit 41 of the action detection server 4 reads the past operation data for the target home appliance 8 (NHi) from the event information (EI), and proceeds to the processing of Step S164.

In Step S164, the control unit 41 of the action detection server 4 calculates comparison data from the past operation data, and proceeds to the processing of Step S165. The control unit 41 calculates the comparison data by averaging the received detection information (NHi, Et, HD), for example.

In Step S165, the control unit 41 of the action detection server 4 compares the detection information (NHi, Et, HD) with the comparison data (CD). If the difference exceeds the threshold value ε₁ (Yes), the control unit 41 judges that an unusual operation has been detected, and proceeds to the processing of Step S167.

In Step S167, the control unit 41 changes the mode to the abnormality mode, and sets the abnormality mode flag EMf to 1.

In Step S165, if the difference is equal to or less than the threshold value ε₁ (No), the control unit 41 of the action detection server 4 judges that it is a normal state, and adds the detection information to the event information (EI) (S166). Thereafter, the control unit 41 proceeds to the processing of Step S160.

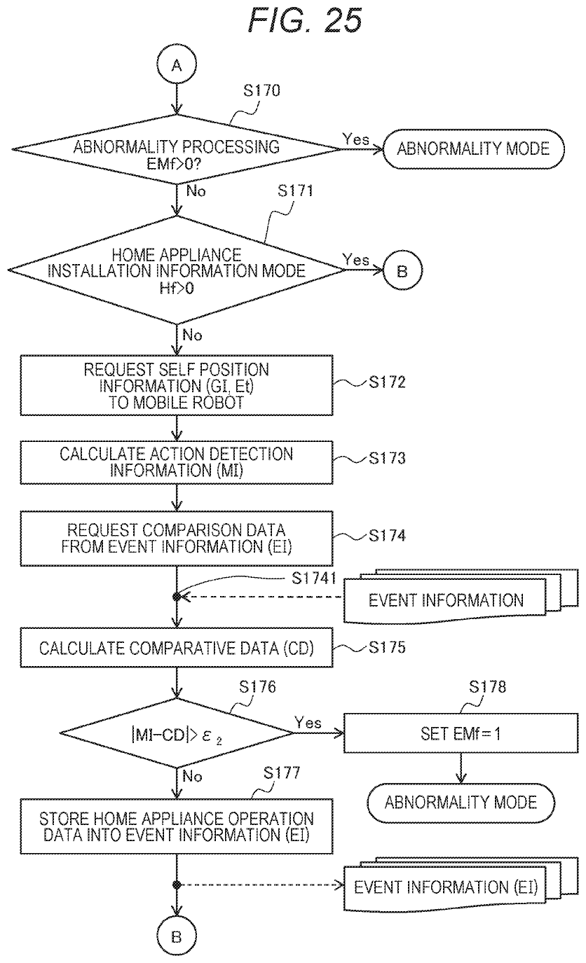

FIG. 25 is a flowchart illustrating processing in the event information (EI) mode when the mobile robot 2 is activated.

In Step S170, the control unit 41 of the action detection server 4 checks whether or not it is an abnormality processing mode by whether or not the abnormality mode flag EMf is set. If the control unit 41 judges that it is the abnormal processing mode, it transitions to the abnormality mode (see FIG. 18) similar to that of the first embodiment. If the control unit 41 judges that it is not the abnormal processing mode, it proceeds to the processing of Step S171.

In Step S171, the control unit 41 of the action detection server 4 judges whether or not it is the home appliance installation information mode. If the home appliance installation information flag Hf has been set (Yes), the control unit 41 judges that it is the home appliance installation information mode, and returns to the processing of Step S160 illustrated in FIG. 24. If the home appliance installation information flag Hf has been cleared (No), the control unit 41 proceeds to the processing of Step S172.

In Step S172, the control unit 41 of the action detection server 4 requests the self position information GI (R, X, Y) to the mobile robot 2. When acquiring the self position information GI (R, X, Y) from the mobile robot 2, the control unit 41 proceeds to the processing of Step S173.

In Step S173, the control unit 41 of the action detection server 4 discriminates the detection information of the home appliance 8 reacting due to the mobile robot 2 from the self position information GI (R, X, Y) of the mobile robot 2 and the home appliance installation information (HI). The control unit 41 discriminates that the detection information of the home appliances 8 other than the home appliance 8 reacting due to the mobile robot 2 is the action detection information (MI) of the mobile body such as a human or an animal, and proceeds to the processing of Step S174.

In Step S174, the control unit 41 of the action detection server 4 requests, to the event information (EI), data to be compared with the action detection information (MI).

In Step S1741, the control unit 41 acquires the requested data, and proceeds to the processing of Step S175.

In Step S175, the control unit 41 of the action detection server 4 calculates the comparison data (CD) from the data obtained from the event information (EI), and proceeds to the processing of Step S176.

In Step S176, the control unit 41 of the action detection server 4 compares the action detection information (MI) with the comparison data (CD). If the result of the comparison exceeds the threshold value ε₂ (Yes), the control unit 41 of the action detection server 4 judges that it is an abnormal state, proceeds to the processing of Step S178, sets the processing state to the abnormality mode, and sets the abnormality mode flag EMf to 1. If the compared result is equal to or less than the threshold value ε₂ (No), the control unit 41 proceeds to the processing of Step S177.

In Step S177, the control unit 41 of the action detection server 4 adds the action detection information (MI) to the event information (EI), and returns to the processing of Step S160 illustrated in FIG. 24.

(Variation)

The present invention is not limited to the embodiments described above, and includes various variations. For example, the embodiments described above have been described in detail for the purpose of explaining the present invention in an easy-to-understand manner, and are not necessarily limited to those including all the components described above. A part of the configuration of a certain embodiment can be replaced with the configuration of another embodiment, and the configuration of another embodiment can be added to the configuration of a certain embodiment. It is also possible to add, delete, or replace another configuration to, from, or with a part of the configuration of each embodiment.

Each of the components, functions, processing units, processing means, and the like described above may partially or entirely be implemented by hardware such as an integrated circuit. Each of the components, functions, and the like described above may be implemented by software by the processor interpreting and executing a program that implements each function. Information such as programs, tables, and files that implement each function can be put in a recording device such as a memory, a hard disk, and a solid state drive (SSD), or a recording medium such as a flash memory card and a digital versatile disk (DVD).

In each embodiment, the control lines and the information lines that are considered to be necessary for explanation are illustrated, and not all the control lines and the information lines in the product are necessarily illustrated. In practice, it may be considered that almost all the components are interconnected.

Variations of the present invention include the following (a) to (e).

(a) The mobile robot 2 may execute processing of the event information mode and processing of the abnormality mode without providing the action detection server 4.

(b) Each sensor device 1 may autonomously execute processing of the event information mode and processing of the abnormality mode without providing the action detection server 4.

(c) The communication unit 44 and the external communication unit 45 of the action detection server 4 may be common.

(d) The mobile robot 2 of the first embodiment may include a wireless tag, and the sensor device 1 may detect the wireless tag. This allows the sensor device 1 to reliably detect the mobile robot 2.

(e) The sensor position information stored in the storage unit may be modified when a change in the sensor position is detected even after the sensor installation information mode ends.

### REFERENCE SIGNS LIST

S action detection system
1, 1-1 to 1-7 sensor device
11 control unit
12 detection unit (first sensor)
13 storage unit
14 communication unit (first communication means)
15 power supply unit
2 mobile robot
21 control unit
22 detection unit (second sensor)
23 mechanism unit
24 storage unit
25 power supply unit
26 operation unit
27 communication unit (second communication means)
3 power feed device
31 detection unit
32 communication unit
4 action detection server
41 control unit
42 storage unit
43 timer
44 communication unit (third communication means)
45 external communication unit (external communication means)
5 external power supply
8, 8-1 to 8-7 home appliances (sensor devices)
81 control unit
82 detection unit (first sensor)
83 storage unit
84 communication unit (first communication means)
85 power supply unit
9 habitable room

1. A robot, comprising:
a communication means capable of communicating with a plurality of sensor devices provided in a room;
a movement means capable of moving in the room;
a detection means; and
a control means for detecting an action of a mobile body on a basis of first detection information detected by the plurality of sensor devices and second detection information detected by the detection means.

2. The robot according to claim 1, wherein
the plurality of sensor devices are home appliances, and
the communication means receives operation information of the home appliances.

3. The robot according to claim 1, wherein
the detection means includes a position sensor for detecting geometric information of a space in which the robot itself has moved, and
the robots includes a storage means for storing sensor position information indicating positions where the plurality of sensor devices are installed, and a correspondence relationship between geometric information of a space where the robot itself has moved and information on positions where the plurality of sensor devices are provided.

4. The robot according to claim 3, wherein
the control means stores, in the storage means, a position where a plurality of sensor devices are provided, as position information expressed by a coordinate system of a space that the robot itself has detected by the position sensor.

5. The robot according to claim 3, wherein
when the detection means detects information, the control means holds the detected information into the storage means, and diagnoses an abnormality state by comparing current information with past information held in the storage means.

6. The robot according to claim 5, wherein
when diagnosing as an abnormality state, the control means moves the robot itself to coordinates of a sensor device that has detected an abnormality, and diagnoses the abnormality.

7. The robot according to claim 6, comprising:
a sensor that diagnoses detail of an abnormality; and
an external communication means for communicating with an outside, wherein
when confirming an abnormality, the control means causes the external communication means to transmit confirmed abnormality information to an outside.

8. An action detection server, comprising:
a communication means capable of communicating with a plurality of sensor devices provided in a room and a robot including a movement means capable of moving in the room; and
a control means for detecting an action of a mobile body on a basis of first detection information detected by the plurality of sensor devices and second detection information detected by the robot.

9. An action detection system built with
a plurality of sensor devices including a first sensor that detects information and a first communication means for transmitting information, and provided in anywhere in a room,
a robot including a second sensor that detects information, a second communication means for transmitting and receiving information, and a movement means capable of moving in the room, and
a server including a third communication means for transmitting and receiving information, the server that detects an action of a mobile body on a basis of detection information of the first sensor included in the plurality of sensor devices and detection information of the second sensor included in the robot.

10. The robot according to claim 2, wherein
the detection means includes a position sensor for detecting geometric information of a space in which the robot itself has moved, and
the robots includes a storage means for storing sensor position information indicating positions where the plurality of sensor devices are installed, and a correspondence relationship between geometric information of a space where the robot itself has moved and information on positions where the plurality of sensor devices are provided.

11. The robot according to claim 10, wherein
the control means stores, in the storage means, a position where a plurality of sensor devices are provided, as position information expressed by a coordinate system of a space that the robot itself has detected by the position sensor.

12. The robot according to claim 4, wherein
when the detection means detects information, the control means holds the detected information into the storage means, and diagnoses an abnormality state by comparing current information with past information held in the storage means.

13. The robot according to claim 10, wherein
when the detection means detects information, the control means holds the detected information into the storage means, and diagnoses an abnormality state by comparing current information with past information held in the storage means.

14. The robot according to claim 11, wherein
when the detection means detects information, the control means holds the detected information into the storage means, and diagnoses an abnormality state by comparing current information with past information held in the storage means.

15. The robot according to claim 12, wherein
when diagnosing as an abnormality state, the control means moves the robot itself to coordinates of a sensor device that has detected an abnormality, and diagnoses the abnormality.

16. The robot according to claim 13, wherein
when diagnosing as an abnormality state, the control means moves the robot itself to coordinates of a sensor device that has detected an abnormality, and diagnoses the abnormality.

17. The robot according to claim 14, wherein
when diagnosing as an abnormality state, the control means moves the robot itself to coordinates of a sensor device that has detected an abnormality, and diagnoses the abnormality.

18. The robot according to claim 15, comprising:
a sensor that diagnoses detail of an abnormality; and
an external communication means for communicating with an outside, wherein
when confirming an abnormality, the control means causes the external communication means to transmit confirmed abnormality information to an outside.

19. The robot according to claim 16, comprising:
a sensor that diagnoses detail of an abnormality; and
an external communication means for communicating with an outside, wherein
when confirming an abnormality, the control means causes the external communication means to transmit confirmed abnormality information to an outside.

20. The robot according to claim 17, comprising:
a sensor that diagnoses detail of an abnormality; and
an external communication means for communicating with an outside, wherein
when confirming an abnormality, the control means causes the external communication means to transmit confirmed abnormality information to an outside.
